(19) United States
(12) Patent Application Publication
(10) Pub. No.: US 2004/0183890 A1
(43) Pub. Date: Sep. 23, 2004

(54) Color image forming appartus

(76) Inventors: Junshin Sakamoto, Hitachinaka (JP); Takeshi Mochizuki, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/802,842

(22) Filed: Mar. 18, 2004

(30) Foreign Application Priority Data
Mar. 18, 2003 (JP) 2003-074374

(51) Int. Cl. B41J 2/455

(52) U.S. Cl. 347/233

(57) ABSTRACT

A color image forming apparatus is provided with a semiconductor laser array 1 of which laser beam emitting points 1-1˜1-12 are arranged m (m≧2) in the row direction thereof and n in the line direction thereof as the same number of the photosensitive drums 9; a beam splitting means 4 which splits the respective laser beams for every lines on the semiconductor laser array 1 so that m laser beams emitted from one of the rows on the semiconductor laser array 1 scan a same photosensitive drum 9 among thereof; and a beam deflection means 6 which deflects in common n laser beams for every lines emitted from the semiconductor laser array 1 and irradiates the same onto the respective photosensitive drums 9, wherein, the arrangement direction of m beam spots irradiated onto one of the photosensitive drums 9 is inclined by an angle α2 with respect to the main scanning direction, thereby, through the common use of the scan optical system for the plurality of laser beams the size and cost of the apparatus are reduced.

### BACKGROUND OF THE INVENTION

1. Field of the Invention

The present invention relates to a color image forming apparatus which permits printing by a plurality of colors and in particular relates to a scanning optical system for the apparatus.

2. Conventional Art

Conventionally, a so called tandem type color laser beam printer which is constituted by a plurality of scanning optical systems and a plurality of electro photographic units has been known. Latent images, for example, for cyan, magenta, yellow and black, which correspond to the respective colors are drawn by the scanning optical systems on respective charged photosensitive drums. A toner image obtained by developing the latent images by a developing unit is transferred on a paper transported with a transport belt, thereafter, the toner image is fixed by a fixing unit to form a color image.

The tandem type color laser beam printer necessitates four scanning optical systems. If the number of the scanning optical systems can be reduced, a great advantage of cost reduction of the apparatus is expected. In particular, the number of polygon scannermotors can be reduced, in addition to such cost reduction, an electric power consumption can also be reduced.

Therefore, measures for reducing the number of the polygon scannermotors have been proposed conventionally. For example, JP-A-3-42612 discloses a technique in which in a tandem type color laser beam printer using four photosensitive drums, a single polygon scannermotors is prepared and through irradiating laser beams from both right and left direction of the polygon scanner, four laser beams are scanned at the same time by different mirror faces.

However, in the apparatus disclosed in JP-A-3-42612 although the single polygon scanner itself can be used in common, the corresponding optical systems for the respective laser beams that irradiate onto four photosensitive drums have to be provided independently, the size of the total optical systems can not be fully reduced.

For this reason, JP-A-6-286226 proposes a color image forming apparatus of reduced size and cost in which the optical parts which irradiate a plurality of laser beams on a plurality of photosensitive drums are used in common.

The disclosed color image forming apparatus is constituted by a semiconductor laser array which emits four laser beams, a polygon mirror which reflects and deflects in common the four laser beams emitted from the semiconductor array, reflection mirrors which guide the four deflection beams reflected and deflected by the polygon mirror in predetermined directions, an f-θ lens which causes to focus the four laser beams reflected by the reflection mirrors in the main scanning direction and to scan at an equal speed on exposure lines on the photosensitive drums, a prism type reflection mirror which splits the four laser beams passed through the f-θ lens in directions depending on the arrangement locations of the photosensitive drums, further reflection mirrors which respectively guide the four laser beams split by the prism type reflection mirror in the corresponding photosensitive drums and cylindrical lenses which respectively cause to focus the four laser beams reflected by the reflection mirrors to the sub-scanning direction.

In the above structure, when the four laser beams, which are modulated depending on the image data of cyan (C), magenta (M), yellow (Y) and black (B), are emitted from the semiconductor laser array, the laser beams are reflected and deflected in common at the polygon mirror and make incidence to the prism type reflection mirror via the reflection mirrors and the f-θ lens and wherein the laser beams are split in the directions depending on the arrangement positions of the respective photosensitive drums. The split four laser beams are respectively reflected by the reflection mirrors, which guide the same to the respective corresponding photosensitive drums, expose the rotating photosensitive drums charged in advance via the cylindrical lenses and form electrostatic latent images on the surface of the photosensitive drums.

As another embodiment thereof, a semiconductor laser array, which emit eight laser beams arranged longitudinally is used, the eight laser beams are transmitted in bundle, respective optical paths are split for every groups each having two laser beams by a beam splitting means and an interlaced scanning by two lines longitudinally on the respective photosensitive drums is performed. Further, in further embodiments, a multi beam semiconductor laser array having different element intervals is used as well as through provision of a micro lens array between the multi beam semiconductor laser array and a collimator a continued scanning on the respective photosensitive drums is performed instead of the interlaced scanning.

However, with such color image forming apparatus, when the number of the laser beams are increased in dependence on high speed demand, the laser beams at both ends of the semiconductor laser array in which the laser beams are arranged longitudinally may exceed beyond the image circle of the lens and be affected aberration, which makes difficult to obtain a predetermined optical performance.

Further, a possible improvement of the above problem may complexes the lens structure, which makes size reduction of the optical unit difficult and increases cost thereof.

Alternatively, when an improvement is tried by narrowing the interval of the elements, the laser beam splitting on to the respective photosensitive drums is made difficult as well as an inconvenience of variation in laser optical output is caused because of droops due to the self heat generation of the laser elements and cross talks due to heat generation by the adjacent laser elements. When the micro lens array is provided between the semiconductor laser array and the collimator, the number of parts and the adjusting steps increase and a problem which is likely affected by imaging position deviation due to thermal deformation depending on the attachment thereof is caused.

### SUMMARY OF THE INVENTION

An object of the present invention is to provide a color image forming apparatus which eliminates the conventional drawbacks as above and achieves high speeding, small sizing and low costing of the apparatus.

The present invention, which achieves the above object is directed to a color image forming apparatus in which on photosensitive drums of n (n≧2) pieces corresponding to respective colors (for example, cyan, magenta, yellow and black) are formed respective latent images by irradiation of laser beams.

A first aspect of the present invention is provided with a semiconductor laser array of which laser beam emitting points are arranged m (m≧2) in the row direction thereof and n in line direction thereof as the same number of the photosensitive drums, beam splitting means, for example, such as a cylindrical lens which splits the respective laser beams for every lines on the semiconductor laser array so that m laser beams emitted from one of the rows on the semiconductor laser array scan a same photosensitive drum among thereof, and beam deflection means, for example, such as a polygon mirror which deflects in common n laser beams for every lines emitted from the semiconductor laser array and irradiates the same onto the respective photosensitive drums, wherein, the arrangement direction of m beam spots irradiated onto one of the photosensitive drums is inclined by an angle α2 with respect to the main scanning direction.

A second aspect of the present invention is provided with a first semiconductor laser array and a second semiconductor laser array each of which laser beam emitting points are arranged m (m≧2) in the row direction thereof and n/2 in line direction thereof as the half number of the photosensitive drums, a first beam splitting means which splits the respective laser beams for every lines on the semiconductor laser array so that m laser beams emitted from one of the rows on the first semiconductor laser array scan a same photosensitive drum among thereof, a second beam splitting means which splits the respective laser beams for every lines on the semiconductor laser array so that m laser beams emitted from one of the rows on the second semiconductor laser array scan a same photosensitive drum among thereof, and beam deflection means which deflects at different faces thereof n laser beams for every lines emitted from the first semiconductor laser array and the second semiconductor laser array and irradiates the same onto the respective photosensitive drums, wherein, the arrangement direction of m beam spots irradiated onto one of the photosensitive drums is inclined by an angle α2 with respect to the main scanning direction.

A third aspect of the present invention is provided with a semiconductor laser array which laser beam emitting points are arranged m (m≧2) in the row direction thereof and n/2 in line direction thereof as the half number of the photosensitive drums, a beam splitting means which splits the respective laser beams for every lines on the semiconductor laser array so that m laser beams emitted from one of the rows on the semiconductor laser array scan a same photosensitive drum among thereof and beam deflection means which deflects in common n/2 laser beams for every lines emitted from the semiconductor laser array and irradiates the same onto the respective photosensitive drums, wherein, the arrangement direction of m beam spots irradiated onto one of the photosensitive drums is inclined by an angle α2 with respect to the main scanning direction.

A fourth aspect of the present invention is characterized in that in any of the first through third aspect inventions by inclining the semiconductor laser array as a whole by an angle α1 the arrangement direction of m beam spots irradiated on the photosensitive drums is inclined by the angle α2 (α1=α2) with respect to the main scanning direction.

A fifth aspect of the present invention is characterized in that in any of the first through third aspect inventions by inclining the alignment in the row direction of the light emitting points with respect to the alignment in line direction by an angle (90°−α3) the arrangement direction of m beam spots irradiated on the photosensitive drums is inclined by the angle α2 (90°−α3=α2) with respect to the main scanning direction.

### BRIEF DESCRIPTION OF THE DRAWINGS

FIG. 1 is a schematic constitutional diagram of a color image forming apparatus representing a first embodiment of the present invention seen from the main scanning direction;

FIG. 2 is a diagram showing beam loci seen from the sub-scanning direction before a polygon mirror in the above color image forming apparatus;

FIG. 3 is a diagram showing beam loci seen from the sub-scanning direction after a polygon mirror in the above color image forming apparatus;

FIG. 4 is a diagram showing arrangement of light sources on a semiconductor laser array used for the above color image forming apparatus;

FIG. 5 is a schematic explanatory diagram showing an arrangement of beam spots on a photosensitive drum in the above color image forming apparatus;

FIG. 6 is a diagram showing a relationship between an arrangement of light sources on a semiconductor laser array and beam spots on a photosensitive drum;

FIG. 7 is a plane view of a semiconductor laser array representing a first modification of the present invention;

FIG. 8 is a plane view of a semiconductor laser array representing a second modification of the present invention;

FIG. 9 is a diagram showing beam loci seen from the sub-scanning direction after a polygon mirror in a color image forming apparatus representing a second embodiment of the present invention;

FIG. 10 is a diagram showing beam loci seen from the sub-scanning direction after a polygon mirror in a color image forming apparatus representing a third embodiment of the present invention;

FIG. 11 is a diagram showing beam loci seen from the sub-scanning direction after a polygon mirror in a color image forming apparatus representing a fourth embodiment of the present invention; and

FIG. 12 is a schematic perspective diagram of a color image forming apparatus representing a fifth embodiment of the present invention.

### DETAILED DESCRIPTION OF THE EMBODIMENTS

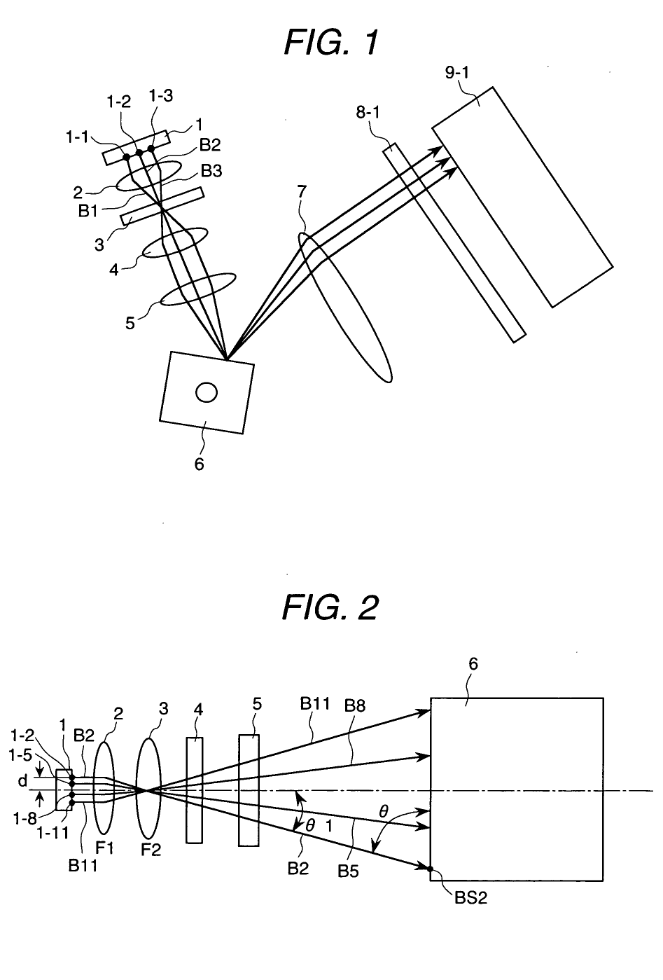

FIG. 1 is a schematic constitutional diagram of a color image forming apparatus representing a first embodiment of the present invention seen from the main scanning direction, of which color image forming apparatus is a tandem type color laser printer.

In the drawing, numeral 1 is a semiconductor laser array which includes 12 light sources (light emitting points) 1-1˜1-12 in total arranged two dimensionally of 3(in row direction) and 4(in line direction) as shown, for example, in FIG. 4(a) and from these light sources 12 laser beams are emitted. In the present embodiment, although the light sources of 3×4 are illustrated, any semiconductor laser array having light sources of m×n(m≧2,n≧2) can be used.

FIG. 1 shows loci of the beams emitted from the light sources 1-1, 1-2 and 1-3 for facilitating understanding. The laser beams B1, B2 and B3 emitted from the light sources 1-1, 1-2 and 1-3 are collimated by a collimator-lens 2 and the respective laser beams are irradiated on a polygon mirror 6 via cylindrical lenses 4 and 5.

The laser beams reflected by the polygon mirror 6 scan the circumferential face of a photosensitive drum 9-1 via an F-θ lens and a cylindrical lens 8-1. For example, a photosensitive belt can be used in exchange for the photosensitive drum. A direction scanned by the polygon mirror 6 is defined as main scanning direction and a direction perpendicular to the main scanning direction, namely moving direction (rotating direction) of the photosensitive drum 9-1 is defined as sub-scanning direction.

The cylindrical lenses 4 and 5 are used for coming close the laser beams B1, B2 and B3 on the mirror face of the polygon mirror 6 with regard to the scanning direction, thereby, an effective scan width on the mirror face of the polygon mirror 6 can be small. The F-θ lens 7 functions so that through rotation of the polygon mirror 6 the beams scan on the photosensitive drum 9-1 in a equal speed.

FIG. 2 shows beam loci from the semiconductor laser array 1 in the line direction to the polygon mirror 6. The beams B2, B5, B8 and B11 emitted from the light sources 1-2, 1-5, 1-8 and 1-11 arranged in the line direction on the semiconductor laser array 1 are collimated by the collimator lens 2, split respectively by the cylindrical lens 3 and imaged on the polygon mirror 6.

Herein, when assuming that the distance from the center point between the light sources 1-2 and 1-11 to the light source 1-2 is d, and a lens optical axis passes the center point, and further assuming that the imaging position of the beam B2 on the polygon mirror 6 is BS2, focal distances of the collimator lens 2 and the cylindrical lens 3 are respectively F1 and F2 and the angle formed by the beam collimated by the collimator lens 2 with respect to the optical axis is θ1, θ1 is defined by a function θ1=f(F1,d,F2) and the beam irradiated onto the polygon mirror 6 is made incident in an angle θ=180°−(θ1+90°) with respect to the mirror face.

In the drawing only the angle with respect to the light source 1-2 was shown, however with respect to the beams emitted from the other light sources the similar relationship stands. In the present embodiment although the cylindrical lens 3 is disposed at the position of the focal distance F1 of the collimator lens 2, however the cylindrical lens is not necessarily disposed at the position.

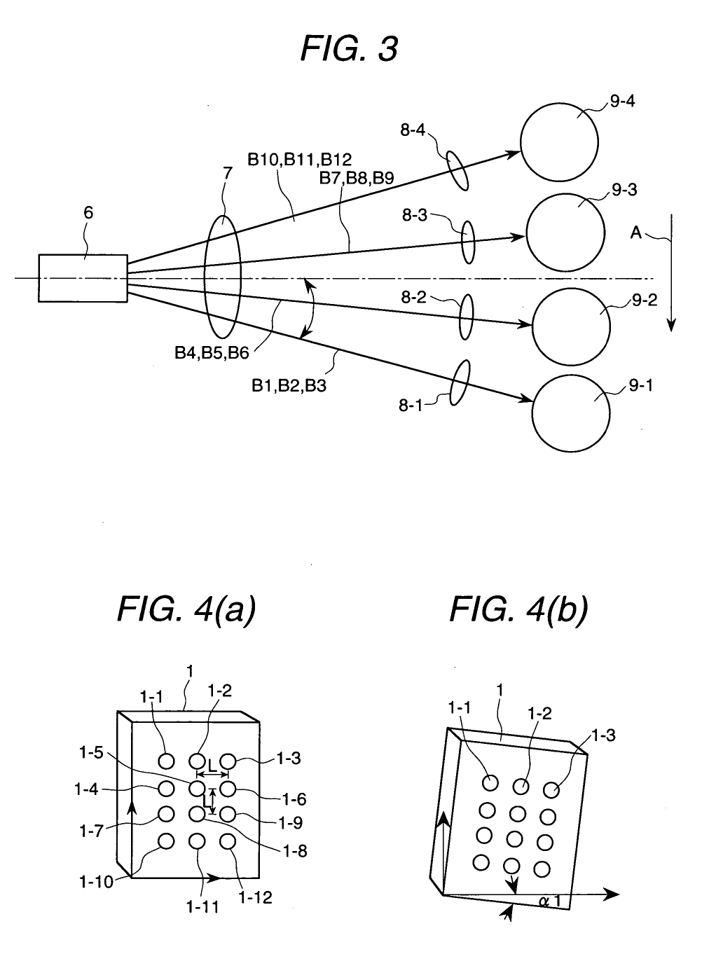

FIG. 3 shows loci in the sub-scanning direction of the beams reflected from the polygon mirror 6. The respective beams B1˜B12 reflected from the polygon mirror 6 are reflected in different angles, the beams B1˜B3 are reflected in substantially the same angle θ(same as the incidence angle θ shown in FIG. 2), and in the like manner the groups of the respective beams B4˜B6, B7˜B9 and B10˜12 are respectively reflected in different angles.

The respective beams B1˜B12 are imaged via the F-θ lens 7 and respective cylindrical lenses 8-1˜8-4 on the respective photosensitive drums 9-1˜9-4 and scan the same. The respective photosensitive drums 9-1˜9-4 are arranged in an equal distance along a transport direction A of such as sheets and an intermediate image transfer body serving as a recording medium. In the present embodiment, the photosensitive drum 9-1 is for black (BK), the photosensitive drum 9-2 is for yellow (Y), the photosensitive drum 9-3 is for magenta (M) and the photosensitive drum 9-4 is for cyan (C) and they are designed to rotate in clockwise direction.

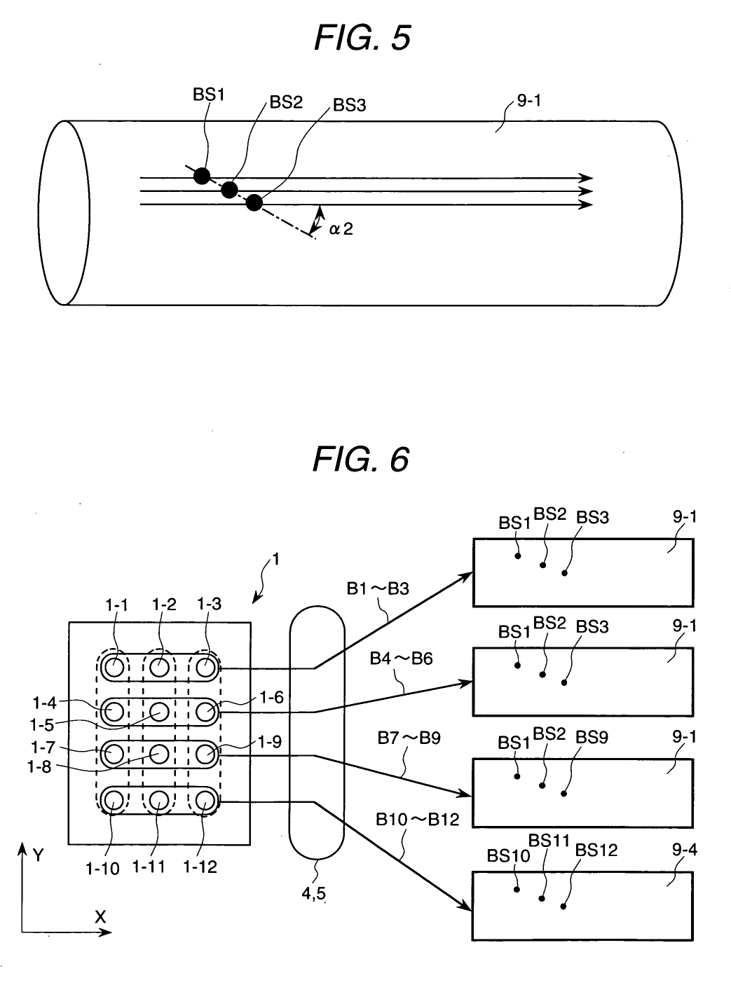

On the respective photosensitive drums 9-1˜9-4 three beams are respectively imaged and scan the same. FIG. 5 shows the disposition of the beam spots on one of the photosensitive drums 9. In the drawing the beam spots BS1˜BS3 of the beams B1˜B3 on the photosensitive drum 9-1 is shown. As shown in the drawing, the arrangement direction of the beam spots BS1˜BS3 is aligned in an angle of α2 with respect to the main scanning direction and when assuming that the printing density is 600 DPI, the scanning interval of the beam spots is 42.3 μm. The inclination α2 can be realized by inclining the semiconductor laser array 1 as a whole by an angle of α1 (α1=α2). In the present embodiment, the angle α1 (=α2) is 19.47°.

FIG. 6 is a diagram showing a relationship between the arrangement of the respective light sources 1-1˜1-12 on the semiconductor laser array 1 and the beam spots BS1˜BS12 on the photosensitive drums 9-1˜9-4.

In the present embodiment as shown in the drawing, 12 light sources 1-1˜1-12 in total are arranged in an equal interval, in that 3 for row direction (X direction) and 4 for line direction (Y direction) which meets the number of the photosensitive drums 9-1˜9-4.

The beams B1˜B3 arranged on the first row and emitted from the light sources 1-1˜1-3 are irradiated onto the photosensitive drum 9-1 and form the beam spots BS1˜BS3. Likely, by the light sources 1-4˜1-6 on the second row the beam spots BS4˜BS6 on the photosensitive drum 9-2, by the light sources 1-7˜1-9 on the third row the beam spots BS7˜BS9 on the photosensitive drum 9-3 and by the light sources 1-10˜1-12 on the fourth row the beam spots BS10˜BS12 on the photosensitive drum 9-4 are respectively formed.

In order that the three laser beams emitted from one row on the semiconductor laser array 1 scan a same photosensitive drum 9, the cylindrical lenses 4 and 5 are used which serve as a beam splitting means for splitting the respective laser beams for every rows on the semiconductor laser array 1.

The polygon mirror 6 is used which serves as a beam deflecting means for deflecting in common the beams B1, B4, B7 and B10 emitted from the light sources 1-1, 1-4, 1-7 and 1-10 arranged on the first line and irradiating the same onto the respective photosensitive drums 9-1, ˜9-4.

A proper interval L between the light sources (light emitting points) on the semiconductor laser array 1 is more than 50 μm, if the interval is less than 50 μm, the beam splitting becomes difficult and at the same time a problems such a cross talk between the light sources(light emitting points) are caused.

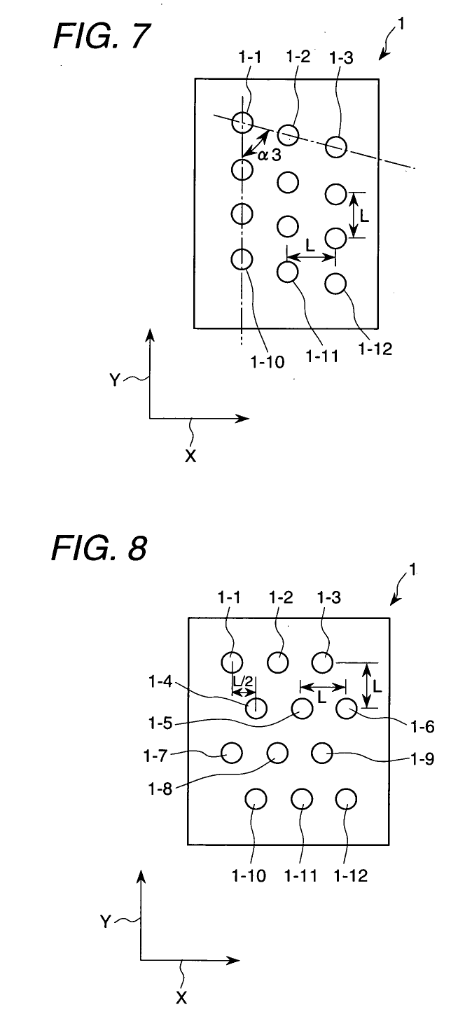

FIG. 7 is a diagram showing a first modification of the semiconductor laser array 1. A difference of the present modification from the embodiment as shown in connection with FIG. 4(b) is that the alignment in row direction (X direction)of the light sources 1-1˜1-12 is in advance inclined by an angle of (90°−α3) with respect to the alignment in the line direction (Y direction), the arrangement direction of the three beam spots irradiated on the photosensitive drum 9 is resultantly inclined by an angle of α2(=90°−α3) with respect to the main scanning direction. Accordingly, with the present modification it is unnecessary to incline the semiconductor laser array 1 as a whole by the angle of α1 as shown in FIG. 4(b).

FIG. 8 is a diagram showing a second modification of the semiconductor laser array 1. A difference of the present modification from the embodiment as shown in FIG. 4(b) is that he number of the light sources 1-1˜1-12 is determined to be half number (n/2) of the number of the photosensitive drums, namely two for every lines and the interval between the lines is determined as L/2.

Now an image distortion caused when the laser beams make incidence in an inclined manner with respect the optical axis of the F-θ lens 7 will be discussed.

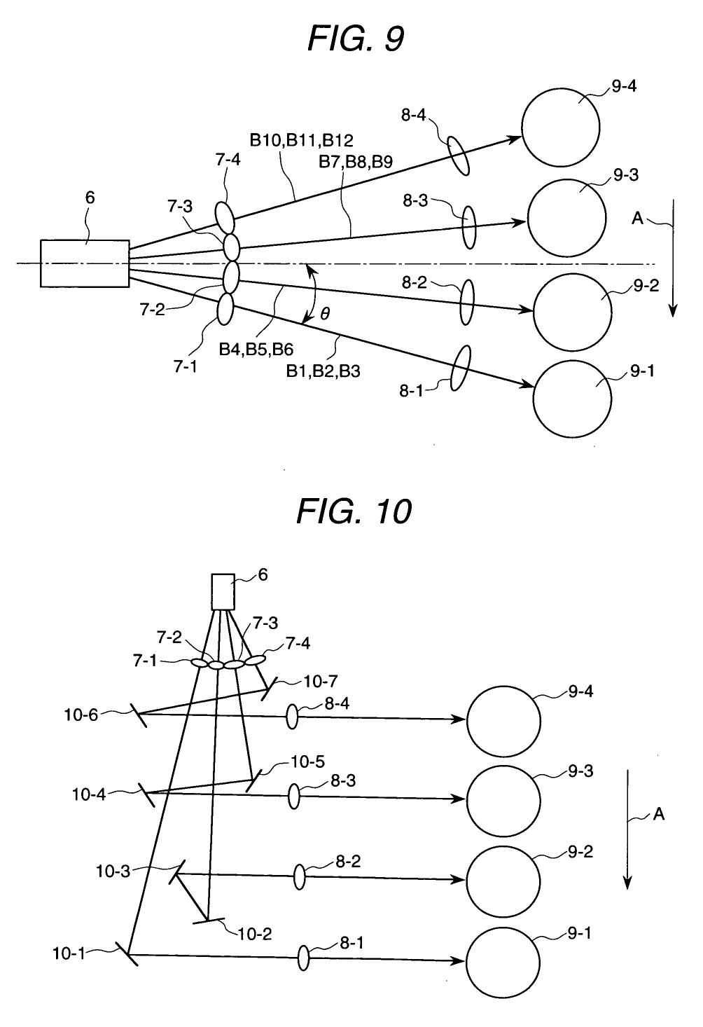

In the scanning lines scanned by the laser beams making incidence in an inclined manner with respect to the optical axis of the F-θ lens 7 an arcuate bent can be caused on the imaging face, namely, on the photosensitive drum 9 due to distorted aberration. The phenomenon, which causes the bent in the scanning lines is a significant problem for a multi beam laser printer in which a photosensitive drum is inclusively scanned by a plurality of laser beams. The above problem can be resolved when individually divided F-θ lenses are disposed to be substantially perpendicular with respect to the ray directions of the respective beams. Namely, through the provision of the four F-θ lenses 7-1˜7-4 as shown in FIG. 9, the bent of the scanning lines can be suppressed (second embodiment).

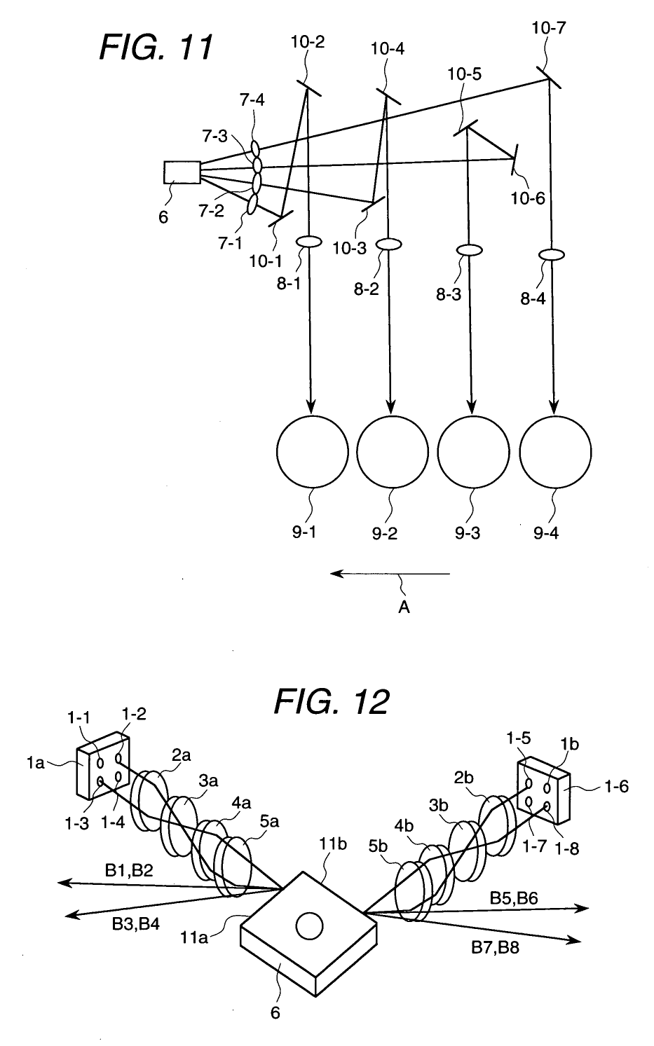

In FIGS. 10 and 11 which relate to third and fourth embodiments, reflection mirrors 10-1˜10-7 are provided between the respective F-θ lenses 7-1˜7-4 and the respective cylindrical lenses 8-1˜8-4, thereby, the arrangement relation between the photosensitive drums 9-1˜9-4 is modified. The number and the position of the reflection mirrors for the respective beams are determined so that the lengths of the optical paths of the respective beams are the same.

In the above embodiments, an instance of four photosensitive drums and the light source arrangement of 4×m (m≧2) was explained, however, the two dimensional beam arrangement has to be modified depending on the number of the photosensitive drums. Namely, when assuming that the number of the photosensitive drums is n, the light source arrangement on a semiconductor laser array is determined to be as n×m (n≧2,m≧2).

FIG. 12 is a diagram showing a fifth embodiment in which two semiconductor laser arrays are used. Namely, the two semiconductor laser arrays constituted by a first semiconductor laser array la and a second semiconductor laser array 1b in each of which two light sources are respectively arranged both in the row and line directions. The semiconductor laser arrays 1a and 1b are inclined by an angle of α1 in the like manner as in FIG. 4(b).

The laser beams B1˜B4 emitted from the light sources 1-1˜1-4 on the first semiconductor laser array 1a are irradiated on a first reflection face 11a of the polygon mirror 6 via the first collimator lens 2a and the first cylindrical lenses 3a, 4a and 5a. The laser beams B1, B2 and B3, B4 are split by the first cylindrical lenses 4a and 5a, deflected in common by the first reflection face 11a of the polygon mirror 6 and led to the sides of the photosensitive drums 9-1 and 9-2 (not shown).

The laser beams B5˜B8 emitted from the light sources 1-5˜1-8 on the second semiconductor laser array 1b are irradiated on a second reflection face 11b different from the first reflection face 11a of the polygon mirror 6 via the second collimator lens 2b and the second cylindrical lenses 3b, 4b and 5b. The laser beams B5, B6 and B7, B8 are split by the second cylindrical lenses 4b and 5b, deflected in common by the second reflection face 11b of the polygon mirror 6 and led to the sides of the photosensitive drums 9-3 and 9-4 (not shown).

In the above embodiments, in order that the m laser beams emitted from one row on the semiconductor laser array scan a same photosensitive drum, the cylindrical lenses are used which serve as a beam splitting means for splitting the respective laser beams for every rows on the semiconductor laser array, however, other beam splitting means such as a prism can be used in place of the cylindrical lenses.

When the above multi beam semiconductor laser arrays are applied for a tandem type laser beam printer or a one-path multi color type laser beam printer, a small size, low cost and low power consumption laser beam printer having a high printing speed and a highly fine saturation can be realized.

According to the present invention, the optical system in a color image forming apparatus can be used in common, thereby, the size and cost of the apparatus can be achieved. Further, the beam deflection means in the apparatus also can be used in common, thereby, the power consumption of the apparatus can be reduced.

1. A color image forming apparatus in which on photosensitive drums or belts of n (n≧2) pieces corresponding to respective colors are formed respective latent images by irradiation of laser beams comprising,
a semiconductor laser array of which laser beam emitting points are arranged m (m≧2) in the row direction thereof and n in the line direction thereof as the same number of the photosensitive drums or belts;
a beam splitting means which splits the respective laser beams for every lines on the semiconductor laser array so that m laser beams emitted from one of the rows on the semiconductor laser array scan a same photosensitive drum or belt among thereof; and
a beam deflection means which deflects in common n laser beams for every lines emitted from the semiconductor laser array and irradiates the same onto the respective photosensitive drums or belts,
wherein, the arrangement direction of m beam spots irradiated onto one of the photosensitive drums or belts is inclined by an angle α2 with respect to the main scanning direction.

2. A color image forming apparatus in which on photosensitive drums or belts of n (n≧2) pieces corresponding to respective colors are formed respective latent images by irradiation of laser beams comprising,
a first semiconductor laser array and a second semiconductor laser array each of which laser beam emitting points are arranged m (m≧2) in the row direction thereof and n/2 in the line direction thereof as the half number of the photosensitive drums or belts;
a first beam splitting means which splits the respective laser beams for every lines on the semiconductor laser array so that m laser beams emitted from one of the rows on the first semiconductor laser array scan a same photosensitive drum or belt among thereof;
a second beam splitting means which splits the respective laser beams for every lines on the semiconductor laser array so that m laser beams emitted from one of the rows on the second semiconductor laser array scan a same photosensitive drum or belt among thereof; and
a beam deflection means which deflects at different faces thereof n laser beams for every lines emitted from the first semiconductor laser array and the second semiconductor laser array, and irradiates the same onto the respective photosensitive drums or belts,
wherein, the arrangement direction of m beam spots irradiated onto one of the photosensitive drums or belts is inclined by an angle α2 with respect to the main scanning direction.

3. A color image forming apparatus in which on photosensitive drums or belts of n (n≧2) pieces corresponding to respective colors are formed respective latent images by irradiation of laser beams comprising,
a semiconductor laser array of which laser beam emitting points are arranged m (m≧2) in the row direction thereof and n/2 in the line direction thereof as the half number of the photosensitive drums or belts;
a beam splitting means which splits the respective laser beams for every lines on the semiconductor laser array so that m laser beams emitted from one of the rows on the semiconductor laser array scan a same photosensitive drum or belt among thereof; and
a beam deflection means which deflects in common n/2 laser beams for every lines emitted from the semiconductor laser array and irradiates the same onto the respective photosensitive drums or belts,
wherein, the arrangement direction of m beam spots irradiated onto one of the photosensitive drums or belts is inclined by an angle α2 with respect to the main scanning direction.

4. A color image forming apparatus according to claim 1, wherein the semiconductor laser array being inclined as a whole by an angle α1 so that the arrangement direction of m beam spots irradiated on the photosensitive drums or belts is inclined by the angle α2 (α1=α2) with respect to the main scanning direction.

5. A color image forming apparatus according to claim 2, wherein the semiconductor laser array being inclined as a whole by an angle α1 so that the arrangement direction of m beam spots irradiated on the photosensitive drums or belts is inclined by the angle α2 (α1=α2) with respect to the main scanning direction.

6. A color image forming apparatus according to claim 3, wherein the semiconductor laser array being inclined as a whole by an angle α1 so that the arrangement direction of m beam spots irradiated on the photosensitive drums or belts is inclined by the angle α2 (α1=α2) with respect to the main scanning direction.

7. A color image forming apparatus according to claim 1, wherein the alignment in the row direction of the light emitting points being inclined with respect to the alignment in the line direction by an angle (90°−α3) so that the arrangement direction of m beam spots irradiated on the photosensitive drums or belts is inclined by the angle α2 (90°−α3=α2) with respect to the main scanning direction.

8. A color image forming apparatus according to claim 2, wherein the alignment in the row direction of the light emitting points being inclined with respect to the alignment in the line direction by an angle (90°−α3) so that the arrangement direction of m beam spots irradiated on the photosensitive drums or belts is inclined by the angle α2 (90°−α3=α2) with respect to the main scanning direction.

9. A color image forming apparatus according to claim 3, wherein the alignment in the row direction of the light emitting points being inclined with respect to the alignment in the line direction by an angle (90°−α3) so that the arrangement direction of m beam spots irradiated on the photosensitive drums or belts is inclined by the angle α2 (90°−α3=α2) with respect to the main scanning direction.
